(19) United States
(12) Patent Application Publication
(10) Pub. No.: US 2025/0045146 A1
(43) Pub. Date: Feb. 6, 2025

(54) Always On Information Handling System Chassis Intrusion System

(71) Applicant: Dell Products L.P., Round Rock, TX (US)

(72) Inventors: Geroncio O. Tan, Austin, TX (US); Danilo O. Tan, Austin, TX (US); Harpreet S. Narula, Austin, TX (US)

(73) Assignee: Dell Products L.P., Round Rock, TX (US)

(21) Appl. No.: 18/229,503

(22) Filed: Aug. 2, 2023

(51) Int. Cl. G06F 11/07; G06F 11/32; H04W 4/021

(52) U.S. Cl. CPC G06F 11/0793; G06F 11/327; H04W 4/021

(57) ABSTRACT

A system, method, and computer-readable medium for performing a chassis intrusion operation. The chassis intrusion operation includes monitoring an information handling system for occurrence of an intrusion event, the monitoring being performed whether the information handling system is in a powered on state or a powered off state; providing information regarding the intrusion event to a chassis intrusion system, the chassis intrusion system identifying a remediation action to perform in response to the intrusion event; and, performing the action on the information handling system, the remediation action remediating the intrusion event.

### BACKGROUND OF THE INVENTION

### Field of the Invention

The present invention relates to information handling systems. More specifically, embodiments of the invention relate to an always on information handling system intrusion system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

More specifically, in one embodiment the invention relates to a method for performing a chassis intrusion operation comprising monitoring an information handling system for occurrence of an intrusion event, the monitoring being performed whether the information handling system is in a powered on state or a powered off state; providing information regarding the intrusion event to a chassis intrusion system, the chassis intrusion system identifying a remediation action to perform in response to the intrusion event; and, performing the action on the information handling system, the remediation action remediating the intrusion event.

In another embodiment the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: monitoring an information handling system for occurrence of an intrusion event, the monitoring being performed whether the information handling system is in a powered on state or a powered off state; providing information regarding the intrusion event to a chassis intrusion system, the chassis intrusion system identifying a remediation action to perform in response to the intrusion event; and, performing the action on the information handling system, the remediation action remediating the intrusion event.

In another embodiment the invention relates to a computer-readable storage medium embodying computer program code, the computer program code comprising computer executable instructions configured for: monitoring an information handling system for occurrence of an intrusion event, the monitoring being performed whether the information handling system is in a powered on state or a powered off state; providing information regarding the intrusion event to a chassis intrusion system, the chassis intrusion system identifying a remediation action to perform in response to the intrusion event; and, performing the action on the information handling system, the remediation action remediating the intrusion event.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a block diagram of a chassis intrusion environment.

FIGS. 3A and 3B, generally referred to as FIG. 3, show a hardware component focused functional block diagram of a chassis intrusion system.

FIG. 4 shows a flowchart of a chassis intrusion operation.

### DETAILED DESCRIPTION

Certain aspects of the present disclosure include an appreciation that information and asset theft is a growing problem in the government and corporate world. Accordingly, certain aspects of the present disclosure include an appreciation that providing robust real time theft prevention and remediation lessens the odds of these events happening and increasing the chance of recovery in the event it does.

Certain aspects of the disclosure reflect an appreciation that it is desirable to provide chassis intrusion detection for information handling systems, especially when the chassis has been opened without proper authorization. Certain aspects of the disclosure reflect an appreciation that with certain known systems, upon detection, a basic input output system (BIOS) can execute various actions such as recording the intrusion event, escalating the authentication to administrator level, locking the system resources, wiping the system storage clean, or a combination thereof.

Certain aspects of the disclosure include an appreciation that while the known intrusion detection functions provide a more secure system, the functions are an after-the-fact action. I.e., the system has to be powered on to read the intrusion event and to apply remediation actions, which in some cases might be too late. In the case of a stolen system, it does not address the loss of the hardware asset and any confidential information contained within the system. Accordingly, certain aspects of the present disclosure include an appreciation that there is a need for the intrusion detection and remediation solution to continue to operate while the system is in an off state, be able to respond in real time, or a combination thereof.

Accordingly, certain aspects of the disclosure reflect an appreciation that it would be desirable to provide solution for the information handling system to be “always-on” and monitoring for possible attacks or theft, but without sacrificing battery life. Certain aspects of the disclosure reflect an appreciation that it would be desirable to have the information handling system “phone home” in the event its security has been compromised, report its last location, receive real time instruction from an administrator on the proper course of action to take or to execute the pre-deployed mitigation actions.

Certain aspects of the present disclosure include an appreciation that some known intrusion detection systems can detect when the system has been opened without proper authorization. With these known systems upon detection, BIOS can execute a variety of actions such as recording the intrusion event, escalating the authentication to an admin level, locking the system resources, or wipe the system storage clean. Additionally, certain aspects of the present disclosure include an appreciation that with other known systems, it is known to enable a Bluetooth (BT) module to continue to operate while the system is in an off state.

A system, method, and computer-readable medium are disclosed for performing always on information handling system intrusion operation. In certain embodiments, the always on information handling system intrusion operation leverages BT enabled devices where an intrusion alert is sent via the BT module of the BT enabled device. In certain embodiments, the BT enabled devices are contained within a mesh network and upon detection of an intrusion event, the BT module sends an intrusion alert via BT mesh network. In certain embodiments, the wireless mesh network conforms with known wireless mesh networks such as the mesh network designed to function with tracking devices such as TILE type tracking devices.

In certain embodiments, the always on information handling system intrusion operation detects chassis intrusion event when the information handling system is powered off. In certain embodiments, the always on information handling system intrusion operation notifies an administrator of an intrusion event in real time even when system is powered off.

In certain embodiments, the always on information handling system intrusion operation remediates an intrusion event remotely or locally even when system is powered off. In certain embodiments, the always on information handling system intrusion operation automatically applies a remediation policy in real time. In certain embodiments, the remediation policy is defined by an administrator such as an information technology advisor. In certain embodiments, the always on information handling system intrusion operation tracks information handling systems to detect intrusion events in real time even when the information handling system is powered down.

In certain embodiments, the intrusion alert is provided to an intrusion alert console. In certain embodiments, when an intrusion alert is received at the console, instruction can be generated (e.g., by an administrator monitoring the console) on a remediation action to pursue. In certain embodiments, the instructions cause the system to wake to perform the remediation action. In certain embodiments, the intrusion operation can also display warning messages on a display device of the system, generate warning sounds, or a combination thereof, as a deterrent. In certain embodiments, the intrusion operation can cause the system can also take more drastic measures such as a data wipe operation, a hardware component disablement operation, or a combination thereof, to render the system unusable before an intruder can perform any nefarious actions on the system.

In certain embodiments, the intrusion operation can be performed on a set of devices within an IT environment. In certain embodiments, the intrusion operation facilitates asset tracking and protection within an IT environment. In certain embodiments, information handling systems within the IT environment are configured as broadcasters. In certain embodiments, the information handling systems within the IT environment send packets within deterministic time slots that are continuously monitored by the intrusion infrastructure. In certain embodiments, the intrusion infrastructure includes scanners that precisely synchronize with the sub-slot level sub-events. In certain embodiments when the scanners are synchronized, they actively generate intrusion alerts only in intrusion alert specific timeslots. Such a configuration advantageously enables large sets of devices to be monitored at a very low power and with very little air-time.

In certain embodiments, when the physical asset has not been removed from a premise, an intrusion alert can also be sent once the system leaves a Geo-fenced environment, event while the system is off. In certain embodiments, when the system leaves the Geo-fenced environment, the system initiates remediation actions, either under its own control or via instruction sent from a remote chassis intrusion system.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

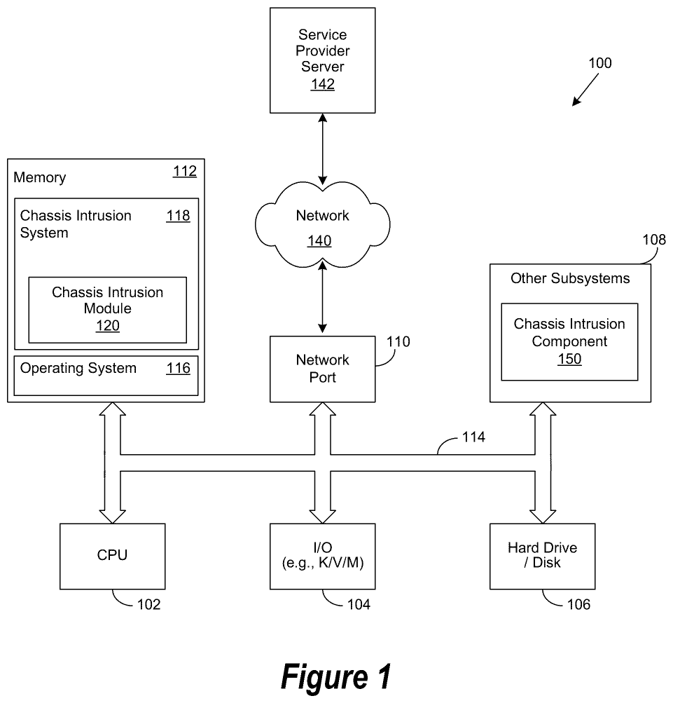

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, a touchpad or touchscreen, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a chassis intrusion system 118. In certain embodiments, the chassis instruction system 118 includes a chassis intrusion module 120. In one embodiment, the information handling system 100 is able to download the chassis intrusion system 118 from the service provider server 142. In another embodiment, the chassis intrusion system 118 is provided as a service from the service provider server 142. In certain embodiments, the other subsystems 108 include a chassis intrusion component 150. The chassis intrusion system 118, the chassis intrusion component 150, or a combination thereof, perform an always on information handling system intrusion operation.

In certain embodiments, the always on information handling system intrusion operation leverages Bluetooth enabled devices where an intrusion alert is sent via a Bluetooth module of the Bluetooth enabled device. In certain embodiments, the Bluetooth module is contained within chassis intrusion component 150. In certain embodiments, the Bluetooth enabled devices are contained within a mesh network (which is part of network 140) and upon detection of an intrusion event, the Bluetooth module sends an intrusion alert via a Bluetooth mesh network. In certain embodiments, the wireless mesh network conforms with known wireless mesh networks such as the mesh network designed to function with tracking devices such as TILE type tracking devices.

In certain embodiments, the always on information handling system intrusion operation detects chassis intrusion event when the information handling system 100 is powered off. In certain embodiments, the always on information handling system intrusion operation notifies an administrator of an intrusion event in real time even when system is powered off.

In certain embodiments, the always on information handling system intrusion operation remediates an intrusion event remotely or locally even when information handling system 100 is powered off. In certain embodiments, the always on information handling system intrusion operation automatically applies a remediation policy in real time. In certain embodiments, the remediation policy is defined by an administrator such as an information technology administrator. In certain embodiments, the always on information handling system intrusion operation tracks information handling systems to detect intrusion events in real time even when the information handling system is powered down.

In certain embodiments, the intrusion alert is provided to an intrusion alert console. In certain embodiments, when an intrusion alert is received at the console, instructions can be generated (e.g., by an administrator monitoring the console) on a remediation action to pursue. In certain embodiments, the instructions cause the system to wake to perform the remediation action. In certain embodiments, the intrusion operation can also display warning messages on a display device of the information handling system 100, generate warning sounds, or a combination thereof, as a deterrent. In certain embodiments, the intrusion operation can cause the information handling system 100 can also take more drastic measures such as a data wipe operation, a hardware component disablement operation, or a combination thereof, to render the system unusable before an intruder can perform any nefarious actions on the information handling system 100.

In certain embodiments, when the physical asset has not been removed from a premise, an intrusion alert can also be sent once the information handling system 100 leaves a Geo-fenced environment, even while the system is off. In certain embodiments, when the information handling system 100 leaves the Geo-fenced environment, the information handling system 100 automatically initiates remediation actions, either under its own control or via instruction sent from a remote chassis intrusion system.

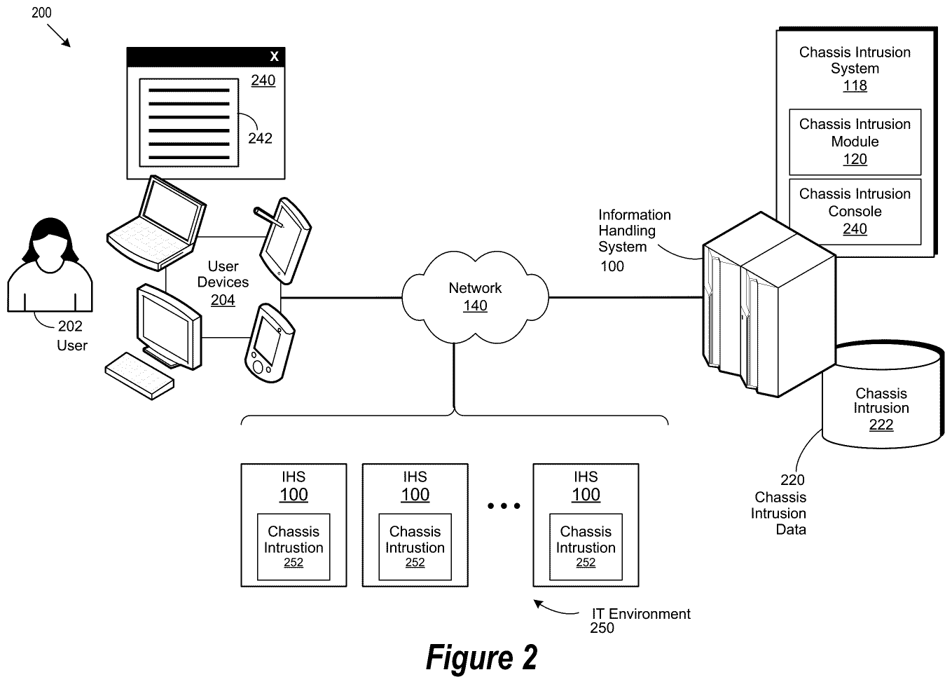

FIG. 2 is a block diagram of a chassis intrusion environment 200 implemented in accordance with an embodiment of the invention. In certain embodiments, the chassis intrusion environment 200 may include a chassis intrusion system 118. In certain embodiments, the chassis intrusion environment 200 may include a repository of chassis intrusion data 220. In certain embodiments, the repository of chassis intrusion data 220 may be local to the system executing the chassis intrusion system 118 or may be executed remotely. In certain embodiments, the repository of chassis intrusion data 220 may include a repository of various information associated with chassis intrusion 222.

In certain embodiments, the chassis intrusion system 118 may include a chassis intrusion module 120 and a chassis intrusion console 240. In certain embodiments, the chassis intrusion module 120, the chassis intrusion console 240, or a combination thereof may be implemented to perform some or all of a chassis intrusion operation.

In certain embodiments, a user 202 may use a user device 204 to interact with the chassis intrusion system 118. As used herein, a user device 204 refers to an information handling system such as a personal computer, a laptop computer, a tablet computer, a personal digital assistant (PDA), a smart phone, a mobile telephone, or other device that is capable of communicating and processing data. In certain embodiments, the user device 204 may be configured to present a chassis intrusion system user interface (UI) 240. In certain embodiments, the chassis intrusion system UI 240 may be implemented to present a graphical representation 242 of chassis intrusion information, which is automatically generated in response to interaction with the chassis intrusion system 118.

In certain embodiments, the user device 204 is used to exchange information between the user 202, the chassis intrusion system 118, an IT environment 250, an information handling system 100 (which may be contained within the IT environment 250) or a combination thereof, through the use of a network 140. In certain embodiments, some or all of the information handling systems 100 include respective chassis intrusion components 252. In certain embodiments, the network 140 may be a public network, such as a public internet protocol (IP) network, a physical private network, a wireless network, a virtual private network (VPN), a mesh network, or any combination thereof. Skilled practitioners of the art will recognize that many such embodiments are possible and the foregoing is not intended to limit the spirit, scope or intent of the invention.

In various embodiments, the chassis intrusion system UI 240 may be presented via a website. In certain embodiments, the website may be provided by one or more of the chassis intrusion system 118 and the chassis intrusion console 240. For the purposes of this disclosure a website may be defined as a collection of related web pages which are identified with a common domain name and is published on at least one web server. A website may be accessible via a public IP network or a private local network.

A web page is a document which is accessible via a browser which displays the web page via a display device of an information handling system. In various embodiments, the web page also includes the file which causes the document to be presented via the browser. In various embodiments, the web page may comprise a static web page, which is delivered exactly as stored and a dynamic web page, which is generated by a web application that is driven by software that enhances the web page via user input to a web server.

The chassis intrusion system 118, the chassis intrusion component 252, or a combination thereof, perform an always on information handling system intrusion operation. In certain embodiments, the always on information handling system intrusion operation can determine whether a chassis intrusion event has occurred during operation of an information handling system 100 whether the information handling system is powered on or powered off. In certain embodiments, the chassis intrusion operation results in the realization of an ability to perform always on chassis intrusion detection.

In certain embodiments, the always on information handling system intrusion operation leverages Bluetooth enabled devices where an intrusion alert is sent via a Bluetooth module of the Bluetooth enabled device. In certain embodiments, the Bluetooth module is contained within chassis intrusion component 252. In certain embodiments, the Bluetooth enabled devices are contained within a mesh network (such as some or all of network 140) and upon detection of an intrusion event, the Bluetooth module sends an intrusion alert via Bluetooth mesh network. In certain embodiments, the wireless mesh network conforms with known wireless mesh networks such as the mesh network designed to function with tracking devices such as TILE type tracking devices.

In certain embodiments, the always on information handling system intrusion operation detects chassis intrusion event when the information handling system 100 is powered off. In certain embodiments, the always on information handling system intrusion operation notifies an administrator of an intrusion event in real time even when system is powered off.

In certain embodiments, the always on information handling system intrusion operation remediates an intrusion event remotely or locally even when information handling system 100 is powered off. In certain embodiments, the always on information handling system intrusion operation automatically applies a remediation policy in real time. In certain embodiments, the remediation policy is defined by an administrator such as an information technology administrator. In certain embodiments, the always on information handling system intrusion operation tracks information handling systems to detect intrusion events in real time even when the information handling system is powered down.

In certain embodiments, the intrusion alert is provided to an intrusion alert console. In certain embodiments, when an intrusion alert is received at the console, instructions can be generated (e.g., by an administrator monitoring the console) on a remediation action to pursue. In certain embodiments, the instructions cause the system to wake to perform the remediation action. In certain embodiments, the intrusion operation can also display warning messages on a display device of the information handling system 100, generate warning sounds, or a combination thereof, as a deterrent. In certain embodiments, the intrusion operation can cause the information handling system 100 can also take more drastic measures such as a data wipe operation, a hardware component disablement operation, or a combination thereof, to render the system unusable before an intruder can perform any nefarious actions on the information handling system 100.

In certain embodiments, the intrusion operation can be performed on a set of devices within an IT environment. In certain embodiments, the intrusion operation facilitates asset tracking and protection within an IT environment 250. In certain embodiments, information handling systems 100 within the IT environment 250 are configured as broadcasters. In certain embodiments, the information handling systems 100 within the IT environment 250 send packets within deterministic time slots that are continuously monitored by the intrusion infrastructure. In certain embodiments, the intrusion infrastructure (e.g., the intrusion system 118, the intrusion module 120, the intrusion component 240, the intrusion component 252, or a combination thereof) includes scanners that precisely synchronize with the sub-slot level sub-events. In certain embodiments when the scanners are synchronized, they actively generate intrusion alerts only in intrusion alert specific timeslots. Such a configuration advantageously enables large sets of devices to be monitored at a very low power and with very little air-time.

In certain embodiments, the IT environment 250 includes one or more Geo-fenced environments. In certain embodiments, when the physical asset has not been removed from a premise (e.g., the IT environment 250), an intrusion alert can also be sent once the information handling system 100 leaves a Geo-fenced environment, even while the system is off. In certain embodiments, when the information handling system 100 leaves the Geo-fenced environment, the information handling system 100 automatically initiates remediation actions, either under its own control or via instruction sent from a remote chassis intrusion system.

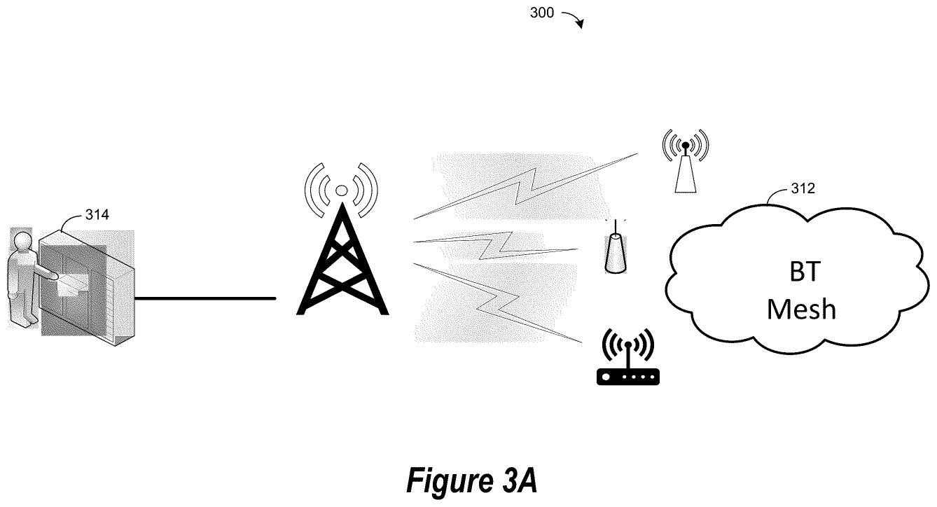

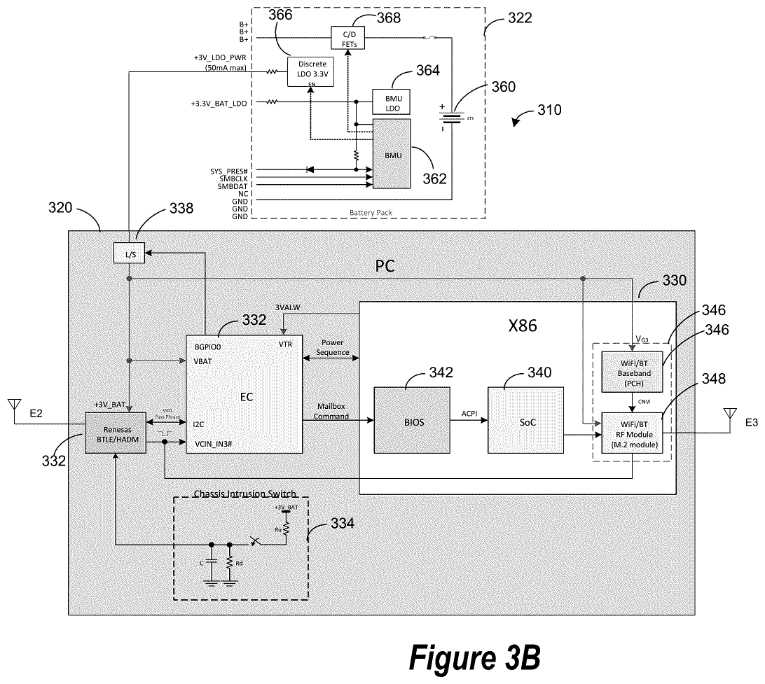

FIGS. 3A and 3B, generally referred to as FIG. 3, show a hardware component focused functional block diagram of a chassis intrusion system 300. More specifically, the chassis intrusion system 300 includes a chassis intrusion detecting information handing system 310 which communicates via a network 312 with an IT administration system 314. In certain embodiments, the network 312 includes a Bluetooth mesh network which communicates wirelessly with the IT administration system 314.

In certain embodiments, the chassis intrusion detecting information handling system includes a component portion 320 and a battery portion 322. In certain embodiments, the component portion 320 includes a processor module 330, an embedded controller component 332, a low power wireless module 334, a chassis intrusion detection component 336, a low side switch (L/S) component 338, or a combination thereof. In certain embodiments, the processor module 330 includes a processor system on a chip (SoC) component 340, a BIOS component, 342 and a Wireless module 344. In certain embodiments, the wireless module 344 includes a baseband controller module 346, a wireless RF module 348, or a combination thereof. In certain embodiments, the chassis intrusion detection component 336 provides a chassis intrusion function. In certain embodiments, the chassis intrusion detection component 336 comprises chassis switch circuitry. In certain embodiments, the chassis switch circuitry includes a switch coupled to the battery portion via a resistor. In certain embodiments, the low side switch connects/disconnects the component portion 320 from the battery portion 322. In certain embodiments, the chassis switch circuitry includes a resistor, a capacitor, or a combination thereof, coupled to ground. In certain embodiments, the battery portion 322 includes a battery 360, battery management unit (BMU) 362, a BMU low dropout (LDO) linear regulator 364, a discrete LDO circuit 366 and a field effect transistor (FET) isolator circuit 368.

In certain embodiments, the embedded controller component 332 is configured to function as a portion of a chassis intrusion component controller. In certain embodiments, the low power wireless module 334 is configured to provide a low power Bluetooth communication function. In certain embodiments, the lower power low power wireless module 334 is configured to provide an always-on communication function. In certain embodiments, the embedded controller component 332 is configured to provide an always-on intrusion control function. In certain embodiments, the chassis intrusion detection component 336 is configured to provide an always-on intrusion detection function. In certain embodiments, the BIOS component 342 includes intrusion detection control code for controlling the processor SoC component 340 to perform intrusion detection operations.

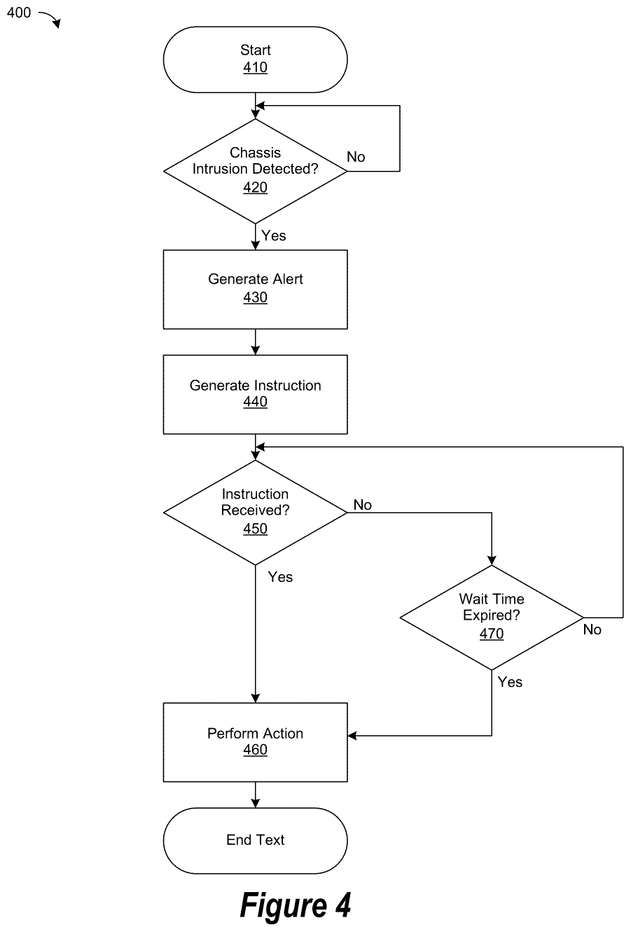

FIG. 4 shows a flow chart of a chassis intrusion operation 400. More specifically, the chassis intrusion operation 400 begins operation at step 410 regardless of whether the information handling system is in a power on state or powered off state. I.e., the chassis intrusion operation 400 is always on. Next, at step 420, the chassis intrusion operation 400 determines whether a chassis intrusion has been detected. In certain embodiments, the determination takes into account the status of a chassis intrusion detection component (such as chassis intrusion detection component 336) of the information handling system. In certain embodiments, the chassis intrusion operation 400 continuously determines whether a chassis intrusion has been detected by repeatedly performing step 420. Next, at step 430, an alert is generated and provided to an IT monitoring device such as a remote IT server. Next, at step 440, the IT monitoring device generates an instruction regarding an action to perform based upon the detection of the chassis intrusion.

Next at step 450, the information handling system with the chassis intrusion determines whether the instruction regarding the action to be performed has been received. When the instruction is received, the chassis intrusion operation 400 performs the action at step 460. While determining whether the instruction has been received, the chassis intrusion operation 400 determines whether (i.e., has a wait time expired) a timeout has occurred at step 470. If a wait time has expired, then the chassis intrusion operation 400 causes the information handling system to perform a predetermined action at step 460. After the action is performed, the chassis intrusion operation 400 completes execution. In various embodiments, the action associated with the instruction, the predetermined action, or a combination thereof, remediate the intrusion event.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing a chassis intrusion operation, comprising:
monitoring an information handling system for occurrence of an intrusion event, the monitoring being performed whether the information handling system is in a powered on state or a powered off state;
providing information regarding the intrusion event to a chassis intrusion system, the chassis intrusion system identifying a remediation action to perform in response to the intrusion event; and,
performing the action on the information handling system, the remediation action remediating the intrusion event.

2. The method of claim 1, wherein:
the remediation action causes the information handling system to wake to perform the remediation action.

3. The method of claim 1, wherein:
the remediation action comprises one or more of displaying a warning message on a display device of the information handling system and generating a warning sound via the information handling system.

4. The method of claim 1, wherein:
the remediation action comprises one or more of performing a data wipe operation on the information handling system and performing a hardware component disablement operation on the information handling system, the one or more of the performing the data wipe operation and performing a hardware component disablement operation rending the information handling system unusable before an intruder can perform a nefarious action on the information handling system.

5. The method of claim 1, wherein:
the information handling system is contained within a geo-fenced information technology (IT) environment;
the monitoring determines when the information handling system is removed from the geo-fenced IT environment; and,
identifying removal of the information handling system from the geo-fenced IT environment as the intrusion event.

6. The method of claim 1, wherein:
the information handling system comprises a Bluetooth module; and
the information handling system communicates with the chassis intrusion system via a Bluetooth mesh network.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
monitoring an information handling system for occurrence of an intrusion event, the monitoring being performed whether the information handling system is in a powered on state or a powered off state;
providing information regarding the intrusion event to a chassis intrusion system, the chassis intrusion system identifying a remediation action to perform in response to the intrusion event; and,
performing the action on the information handling system, the remediation action remediating the intrusion event.

8. The system of claim 7, wherein:
the remediation action causes the information handling system to wake to perform the remediation action.

9. The system of claim 7, wherein:
the remediation action comprises one or more of displaying a warning message on a display device of the information handling system and generating a warning sound via the information handling system.

10. The system of claim 7, wherein:
the remediation action comprises one or more of performing a data wipe operation on the information handling system and performing a hardware component disablement operation on the information handling system, the one or more of the performing the data wipe operation and performing a hardware component disablement operation rending the information handling system unusable before an intruder can perform a nefarious action on the information handling system.

11. The system of claim 7, wherein:
the information handling system is contained within a geo-fenced information technology (IT) environment;
the monitoring determines when the information handling system is removed from the geo-fenced IT environment; and,
identifying removal of the information handling system from the geo-fenced IT environment as the intrusion event.

12. The system of claim 7, wherein:
the information handling system comprises a Bluetooth module; and
the information handling system communicates with the chassis intrusion system via a Bluetooth mesh network.

13. A non-transitory, computer-readable storage medium embodying computer program code, the computer program code comprising computer executable instructions configured for:
monitoring an information handling system for occurrence of an intrusion event, the monitoring being performed whether the information handling system is in a powered on state or a powered off state;
providing information regarding the intrusion event to a chassis intrusion system, the chassis intrusion system identifying a remediation action to perform in response to the intrusion event; and,
performing the action on the information handling system, the remediation action remediating the intrusion event.

14. The non-transitory, computer-readable storage medium of claim 13, wherein:
the remediation action causes the information handling system to wake to perform the remediation action.

15. The non-transitory, computer-readable storage medium of claim 13, wherein:
the remediation action comprises one or more of displaying a warning message on a display device of the information handling system and generating a warning sound via the information handling system.

16. The non-transitory, computer-readable storage medium of claim 13, wherein:
the remediation action comprises one or more of performing a data wipe operation on the information handling system and performing a hardware component disablement operation on the information handling system, the one or more of the performing the data wipe operation and performing a hardware component disablement operation rending the information handling system unusable before an intruder can perform a nefarious action on the information handling system.

17. The non-transitory, computer-readable storage medium of claim 13, wherein:
the information handling system is contained within a geo-fenced information technology (IT) environment;
the monitoring determines when the information handling system is removed from the geo-fenced IT environment; and,
identifying removal of the information handling system from the geo-fenced IT environment as the intrusion event.

18. The non-transitory, computer-readable storage medium of claim 13, wherein:
the information handling system comprises a Bluetooth module; and
the information handling system communicates with the chassis intrusion system via a Bluetooth mesh network.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
